(19) United States
(12) Patent Application Publication
(10) Pub. No.: US 2026/0149775 A1
(43) Pub. Date: May 28, 2026

(54) INFORMATION PROCESSING APPARATUS, AND INFORMATION PROCESSING METHOD

(71) Applicant: SHARP KABUSHIKI KAISHA, Sakai City (JP)

(72) Inventor: Naoto SAITO, Osaka (JP)

(21) Appl. No.: 19/399,921

(22) Filed: Nov. 25, 2025

(30) Foreign Application Priority Data
Nov. 26, 2024 (JP) 2024-205089

(51) Int. Cl. H04N 1/00

(52) U.S. Cl. CPC H04N 1/00084; H04N 1/00037; H04N 1/00063; H04N 2201/0094

(57) ABSTRACT

An information processing apparatus comprises one or more main controllers that control processing of the entire information processing apparatus; a plurality of sub-controllers that control processing of a function executable by the information processing apparatus; and a watchdog timer that detects an occurrence of an abnormality in processing of a first function controlled by a first sub-controller among the plurality of sub-controllers, wherein when the watchdog timer detects an occurrence of an abnormality, the one or more main controllers determine whether to reset the entire information processing apparatus or reset the first sub-controller, based on whether processing executed by the information processing apparatus relates to the processing of the first function controlled by the first sub-controller.

### CROSS-REFERENCE TO RELATED APPLICATION

The present application claims priority from Japanese Application JP2024-205089, the content of which is hereby incorporated by reference into this application.

### BACKGROUND OF THE INVENTION

### 1. Field of the Invention

The present disclosure relates to an information processing apparatus and an information processing method.

### 2. Description of the Related Art

Hitherto, there has been known an apparatus in which, when processing by a slave central processing unit (CPU) is reset by a watchdog timer, a master CPU resets the entire system. For example, there has been known an image forming apparatus in which, when a lower-level device notifies an upper-level device of a WDT reset, the upper-level device initializes the entire system.

### SUMMARY OF THE INVENTION

However, in a publicly-known image forming apparatus, when a notification indicating that a lower-level device executes a WDT reset is received, an upper-level device initializes the entire system, which may degrade system usability.

The present disclosure has been made in view of the problem described above. An object of the present disclosure is to provide an information processing apparatus and an information processing method that can improve usability.

An information processing apparatus of an aspect of the present disclosure includes one or more main controllers that control processing of the entire information processing apparatus, a plurality of sub-controllers that control processing of a function executable by the information processing apparatus, and a watchdog timer that detects an occurrence of an abnormality in processing of a first function controlled by a first sub-controller among the plurality of sub-controllers, wherein, when the watchdog timer detects an occurrence of an abnormality, the one or more main controllers determine whether to reset the entire information processing apparatus or reset the first sub-controller, based on whether processing executed by the information processing apparatus relates to the processing of the first function controlled by the first sub-controller.

An information processing method of an aspect of the present disclosure is an information processing method executed by an information processing apparatus including one or more main controllers that control processing of the entire information processing apparatus, a plurality of sub-controllers that control processing of a function executable by the information processing apparatus, and a watchdog timer that detects an occurrence of an abnormality in processing of a first function controlled by a first sub-controller among the plurality of sub-controllers, wherein, when the watchdog timer detects an occurrence of an abnormality, the one or more main controllers determine whether to reset the entire information processing apparatus or reset the first sub-controller, based on whether processing executed by the information processing apparatus relates to the processing of the first function controlled by the first sub-controller.

According to the present disclosure, it is possible to provide an information processing apparatus and an information processing method that can improve usability.

### BRIEF DESCRIPTION OF THE DRAWINGS

FIG. 1 is a functional block diagram illustrating an example of an information processing apparatus according to an embodiment.

FIG. 2 is a sequence diagram illustrating an example of a processing procedure executed by the information processing apparatus of FIG. 1.

FIG. 3 is a flowchart illustrating an example of decision processing for a reset range that is executed by one or more main controllers of FIG. 1.

FIG. 4 is a flowchart illustrating another example of the decision processing for the reset range that is executed by the one or more main controllers of FIG. 1.

FIG. 5 is an example of a table that is stored in a main storage in FIG. 1 and relates to processing stages.

### DETAILED DESCRIPTION OF THE INVENTION

Embodiments of the present disclosure are described below with reference to the drawings. Note that in the drawings, the same or equivalent constitutional elements are denoted by the same reference signs, and redundant descriptions of the same or equivalent constitutional elements are omitted as appropriate.

### Configuration Example of Information Processing Apparatus

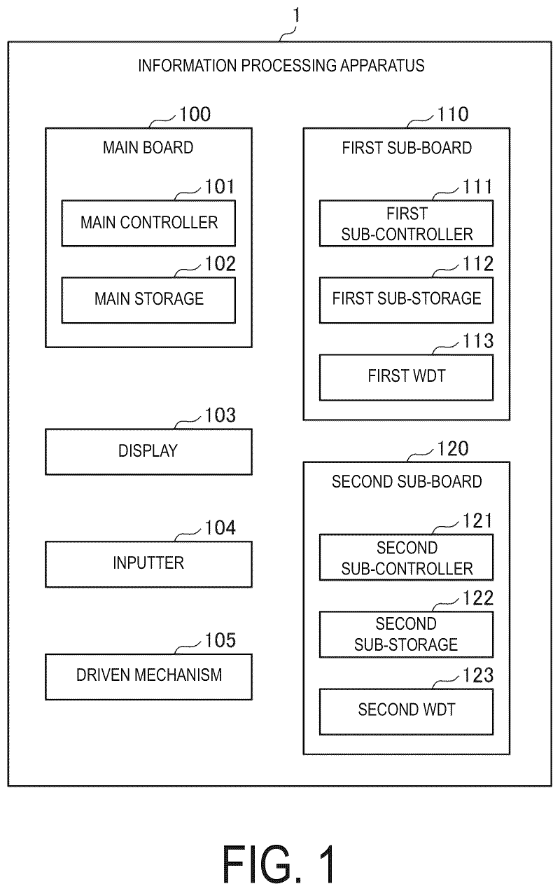

FIG. 1 is a functional block diagram illustrating an example of an information processing apparatus 1 according to an embodiment. The information processing apparatus 1 is constituted by an image forming apparatus, for example. The image forming apparatus is a multifunction apparatus having a plurality of functions such as a copy function, a scan function, a facsimile machine function, and a printer function. However, the information processing apparatus 1 may be constituted by an appropriate apparatus other than the image forming apparatus.

As illustrated in FIG. 1, the information processing apparatus 1 includes a main board 100, a display 103, an inputter 104, a driven mechanism 105, a first sub-board 110, and a second sub-board 120.

The main board 100 is an electronic board on which electronic components are provided. The main board 100 includes one or more main controllers 101 and a main storage 102.

The one or more main controllers 101 control and manage the entire information processing apparatus 1, including the respective functional units of the information processing apparatus 1. Specifically, the one or more main controllers 101 control the processing of the entire information processing apparatus 1. For example, the one or more main controllers 101 execute various types of control by operating a control program stored in the main storage 102. For example, the one or more main controllers 101 may be constituted by a control device such as a central processing unit (CPU) and a micro processing unit (MPU).

The main storage 102 is a storage medium capable of storing a program and data. The main storage 102 can be constituted by, for example, a semiconductor memory, a magnetic memory, or the like. Specifically, the main storage 102 may be constituted by, for example, an electrically erasable programmable read-only memory (EEPROM). The main storage 102 may store, for example, a program for operating the one or more controllers 101.

The display 103 is a device that displays an image. The display 103 is constituted by a publicly-known display such as a liquid crystal display (LCD), an organic electro-luminescence display (OELD), and an inorganic electro-luminescence display (IELD). For example, the display 103 displays various types of information under control of the one or more main controllers 101. For example, the display 103 displays an input screen that receives an input of a job.

The inputter 104 is a mechanism capable of receiving an operation input from a user with respect to the information processing apparatus 1. The inputter 104 is constituted by an operation button group provided to the main body of the information processing apparatus 1, a keyboard, or the like. Further, when a touch sensor is provided to the display 103, the touch sensor provided to the display 103 may function as the inputter 104.

The driven mechanism 105 is a mechanism for executing functions of the information processing apparatus 1. For example, when the information processing apparatus 1 is a multifunction apparatus, the driven mechanism 105 is a mechanism for executing a copy function, a scan function, a facsimile machine function, and a printer function, and the like. In such a case, specifically, the driven mechanism 105 may include an image reading mechanism that reads a front surface of a document, a document feeding mechanism for conveying a document, a printing mechanism for executing charging, light exposure, development, transfer, and fixing in an electrophotographic method, a sheet feeding/conveying mechanism that feeds a sheet from a sheet cassette in which the sheet is accommodated, and the like. However, the driven mechanism 105 is not limited to the examples given herein.

Each of the first sub-board 110 and the second sub-board 120 is an electronic board on which electronic components are provided. The first sub-board 110 includes a first sub-controller 111, a first sub-storage 112, and a first watchdog timer (WDT) 113. The second sub-board 120 includes a second sub-controller 121, a second sub-storage 122, and a second WDT 123.

The first sub-board 110 and the second sub-board 120 are electronic boards for executing respective specific functions. The functions executed by the first sub-board 110 and the second sub-board 120 are different from each other. In the present embodiment, description is made on the assumption that the first sub-board 110 executes printing and the second sub-board 120 executes scanning.

The first sub-controller 111 controls processing of a first function among a plurality of functions executable by the information processing apparatus 1. For example, the first sub-controller 111 executes various types of control by operating a control program stored in the first sub-storage 112. For example, the first sub-controller 111 may be constituted by a control device such as a CPU and an MPU. The first sub-controller 111 is capable of executing information communication with the one or more main controllers 101.

In the present embodiment, the first sub-controller 111 controls processing of a printing function as the first function. Specifically, the first sub-controller 111 operates the printing mechanism and the sheet feeding/conveying mechanism, based on an operation signal from the one or more main controllers 101, which corresponds to an operation input for executing printing processing from a user, and executes the printing processing.

The first sub-storage 112 is a storage medium capable of storing a program and data. The first sub-storage 112 can be constituted by, for example, a semiconductor memory, a magnetic memory, or the like. Specifically, the first sub-storage 112 may be constituted by an EEPROM, for example. The first sub-storage 112 may store, for example, a program for operating the first sub-controller 111.

The first WDT 113 detects an occurrence of an abnormality in the processing of the first function (in this example, the printing function) controlled by the first sub-controller 111. When the first WDT 113 detects an occurrence of an abnormality in the processing of the first function controlled by the first sub-controller 111, the processing executed by the first sub-controller 111 is reset. Further, when a predetermined condition for canceling the reset is satisfied after the reset of the processing executed by the first sub-controller 111, the first WDT 113 cancels the reset.

The second sub-controller 121 controls processing of a second function among the plurality of functions executable by the information processing apparatus 1. For example, the second sub-controller 121 executes various types of control by operating a control program stored in the second sub-storage 122. For example, the second sub-controller 121 may be constituted by a control device such as a CPU and an MPU. The second sub-controller 121 is capable of executing information communication with the one or more main controllers 101.

In the present embodiment, the second sub-controller 121 controls processing of a scan function as the second function. Specifically, the second sub-controller 121 operates the image reading mechanism, based on an operation signal from the one or more main controllers 101, which corresponds to an operation input for executing scan processing from a user, and executes the scan processing.

The second sub-storage 122 is a storage medium capable of storing a program and data. The second sub-storage 122 can be constituted by, for example, a semiconductor memory, a magnetic memory, or the like. Specifically, the second sub-storage 122 may be constituted by an EEPROM, for example. The second sub-storage 122 may store, for example, a program for operating the second sub-controller 121.

The second WDT 123 detects an occurrence of an abnormality in the processing of the second function (in this example, the scan function) controlled by the second sub-controller 121. When the second WDT 123 detects an occurrence of an abnormality in the processing of the second function controlled by the second sub-controller 121, the processing executed by the second sub-controller 121 is reset. Further, when a predetermined condition for canceling the reset is satisfied after the reset of the processing executed by the second sub-controller 121, the second WDT 123 cancels the reset.

Note that, in the present embodiment, the information processing apparatus 1 includes the two sub-boards, namely, the first sub-board 110 and the second sub-board 120, but the number of the sub-boards provided to the information processing apparatus 1 is not limited to two. The information processing apparatus 1 may include a plurality of sub-boards in accordance with executable functions. Each of the plurality of sub-boards includes a sub-controller. Therefore, the information processing apparatus 1 may include a plurality of sub-controllers. Each of the plurality of sub-controllers controls processing of a pre-assigned function of the plurality of functions executable by the information processing apparatus. Further, in the present embodiment, a reset by the first WDT 113 and a reset by the second WDT 123 are also referred to as “WDT resets”.

### Example of Processing

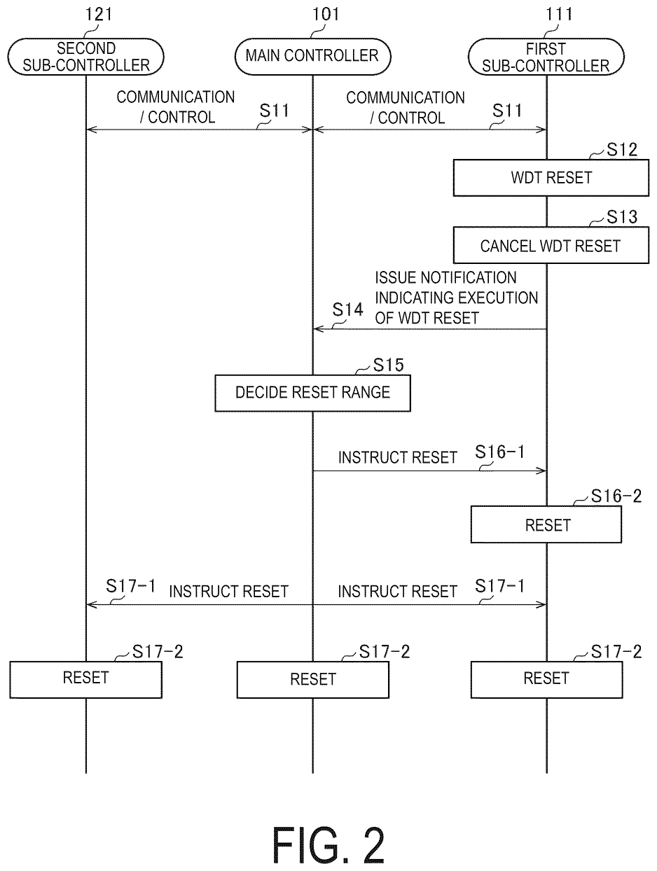

Next, with reference to FIG. 2, processing executed by the information processing apparatus 1 is described. FIG. 2 is a sequence diagram illustrating an example of a processing procedure executed by the information processing apparatus 1 of FIG. 1. At the time of starting the sequence of FIG. 2, it is assumed that all of the one or more main controllers 101, the first sub-controller 111, and the second sub-controller 121 are operated normally.

When all of the one or more main controllers 101, the first sub-controller 111, and the second sub-controller 121 are operated normally, the one or more main controllers 101 execute information communication with the first sub-controller 111 and the second sub-controller 121 to control the first sub-controller 111 and the second sub-controller 121, respectively (Step S11). For example, the one or more main controllers 101 transmit a signal for executing the processing of the predetermined function to the appropriate sub-controller, based on the operation input from the user. The first sub-controller 111 and the second sub-controller 121 execute the processing of the predetermined functions, based on the signals received from the one or more main controllers 101.

Herein, it is assumed that the first WDT 113 detects an occurrence of an abnormality in the processing of the first function by the first sub-controller 111. In such a case, the first WDT 113 executes the WDT reset of the first sub-controller 111 (Step S12). Due to the WDT reset of the first sub-controller 111, the one or more main controllers 101 are in a state in which communication with the first sub-controller 111 cannot be executed.

Subsequently, when the predetermined condition for canceling the reset is satisfied, the predetermined first WDT 113 cancels the WDT reset of the first sub-controller 111 (Step S13). Due to the cancel of the WDT reset, a state in which communication between the one or more main controllers 101 and the first sub-controller 111 can be executed is achieved.

When the WDT reset is canceled, the first sub-controller 111 notifies the one or more main controllers 101 that the WDT reset is executed (Step S14).

When the above-mentioned notification is received, the one or more main controllers 101 decide the reset range in the information processing apparatus 1 (Step S15). Herein, the reset indicates initialization. Specifically, when the first WDT 113 detects an occurrence of an abnormality in the processing executed by the first sub-controller 111, the one or more main controllers 101 determine whether to reset the information processing apparatus 1 or reset the first sub-controller 111. The one or more main controllers 101 decide the reset range, based on whether the processing executed by the information processing apparatus 1 relates to the processing of the first function controlled by the first sub-controller 111. A method of deciding the reset range by the one or more main controllers 101 is described later in detail.

In accordance with the decided reset range, the one or more main controllers 101 reset the entire information processing apparatus 1, or reset only the first sub-controller 111.

For example, when only the first sub-controller 111 is reset, the one or more main controllers 101 transmit a reset signal for instructing the first sub-controller 111 to execute the reset (Step S16-1). In this state, the one or more main controllers 101 simultaneously transmit a command such as a set value required for activation after the reset to the first sub-controller 111.

When the first sub-controller 111 receives the reset signal, the reset of the first sub-controller 111 (initialization) is executed (Step S16-2).

For example, when the entire information processing apparatus 1 is reset, the one or more main controllers 101 transmit a reset signal for instructing the reset to the first sub-controller 111 and the second sub-controller 121 (Step S17-1). In this state, the one or more main controllers 101 simultaneously transmit a command such as a set value required for activation after the reset to the first sub-controller 111 and the second sub-controller 121.

When the first sub-controller 111 and the second sub-controller 121 receive the reset signals, the resets (initialization) of the first sub-controller 111 and the second sub-controller 121 are executed respectively (Step S17-2). Further, the one or more main controllers 101 execute a reset for themselves. With this, initialization of the entire information processing apparatus 1 including the one or more main controllers 101, the first sub-controller 111, and the second sub-controller 121 is executed.

Note that FIG. 2 illustrates both Step S16-1 and Step S16-2, and Step S17-1 and Step S17-2 for the sake of convenience. In actuality, in accordance with the reset range that is decided in Step S15, only one of Step S16-1 and Step S16-2, and Step S17-1 and Step S17-2 is executed.

### Method of Deciding Reset Range

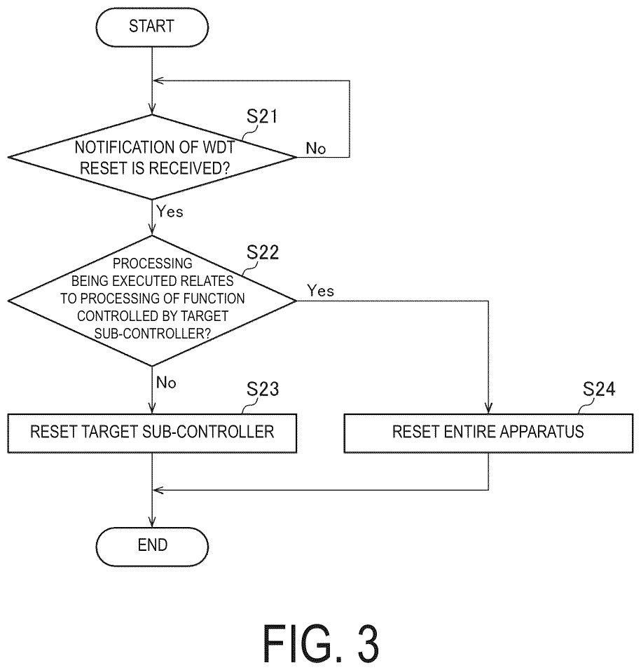

Next, the method of deciding the reset range by the one or more main controllers 101 is described in detail. FIG. 3 is a flowchart illustrating an example of decision processing for the reset range that is executed by the one or more main controllers 101 of FIG. 1. Specifically, FIG. 3 is a flowchart illustrating details of the processing executed in Step S15 of FIG. 2.

The one or more main controllers 101 determine whether the notification indicating the execution of the WDT reset is received from the sub-controller (Step S21). Specifically, the one or more main controllers 101 determine whether the notification described in Step S14 of FIG. 2 is received.

When it is determined that the notification indicating the execution of the WDT reset is not received (No in Step S21), the reset is not executed, and hence the one or more main controllers 101 repeat Step S21.

In contrast, when it is determined that the notification indicating the execution of the WDT reset is received (Yes in Step S21), the one or more main controllers 101 determine whether the processing executed by the information processing apparatus 1 relates to the processing of the function controlled by the target sub-controller (Step S22). Herein, the target sub-controller is the sub-controller that issues the notification indicating the WDT reset, and corresponds to the first sub-controller 111 in the sequence illustrated in FIG. 2. Therefore, when applied to the sequence of FIG. 2, the one or more main controllers 101 determine whether the processing executed by the information processing apparatus 1 relates to the processing of the first function controlled by the first sub-controller 111 (the printing function). For example, the one or more main controllers 101 are capable of determining whether the processing executed by the information processing apparatus 1 relates to the processing of the first function (the printing function), based on communication with the first sub-controller 111 before an occurrence of the WDT reset. For example, when a signal for executing printing is transmitted to the first sub-controller 111, and a notification indicating that the printing is completed is not received from the first sub-controller 111, the one or more main controllers 101 determine that the processing executed by the information processing apparatus 1 relates to the processing of the printing function.

When it is determined that the processing executed by the information processing apparatus 1 does not relate to the processing of the first function controlled by the target sub-controller (the first sub-controller 111) (No in Step S22), the one or more main controllers 101 determine to reset the target sub-controller (the first sub-controller 111) (Step S23). In this manner, even in a case in which the WDT reset occurs in the first sub-controller 111, when the processing executed by the information processing apparatus 1 does not relate to the processing of the first function controlled by the first sub-controller 111, control of the entire information processing apparatus 1 is not affected. Thus, it is only required to reset the first sub-controller 111 where the WDT reset is executed.

When it is determined to reset the target sub-controller (the first sub-controller 111), the one or more main controllers 101 transmit the reset signal to the first sub-controller 111 as described with Step S16-1 of FIG. 2.

In contrast, it is determined that the processing executed by the information processing apparatus 1 relates to the processing of the first function controlled by the target sub-controller (the first sub-controller 111) (Yes in Step S22), the one or more main controllers 101 determine to reset the entire information processing apparatus 1 (Step S24). In a case in which the WDT reset occurs in the first sub-controller 111, when the processing executed by the information processing apparatus 1 relates to the processing of the first function controlled by the first sub-controller 111, control of the entire information processing apparatus 1 may be affected. Thus, in order to prevent discrepancy in information recognition between the one or more main controllers 101 and the plurality of sub-controllers, the reset of the entire information processing apparatus 1 is conceived to be appropriate.

When it is determined to reset the entire information processing apparatus 1, the one or more main controllers 101 transmit the reset signals to the first sub-controller 111 and the second sub-controller 121 as described with Step S17-1 of FIG. 2. Further, as described with Step S17-2 of FIG. 2, the one or more main controllers 101 execute a reset for themselves.

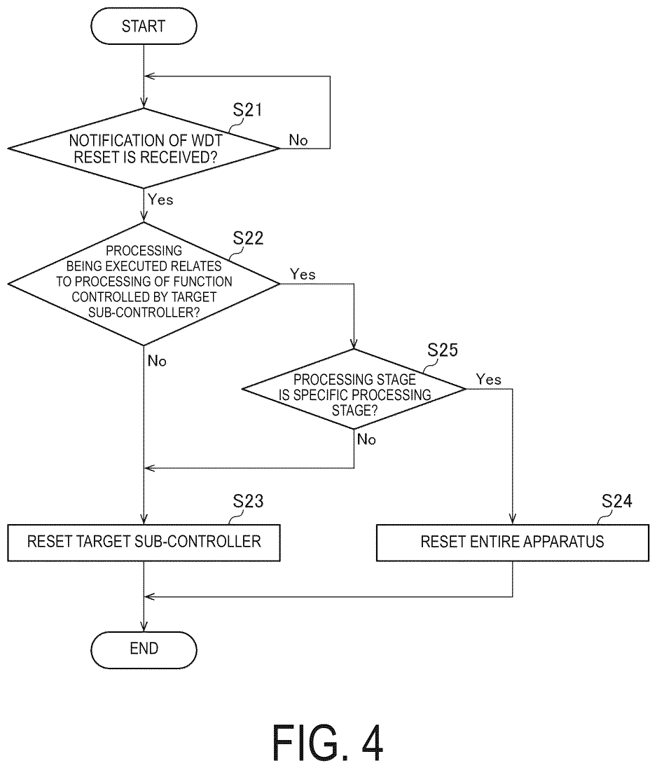

FIG. 4 is a flowchart illustrating another example of the decision processing for the reset range that is executed by the one or more main controllers 101 of FIG. 1. The flowchart of FIG. 4 is described while the description on the points similar to those in FIG. 3 is omitted as appropriate.

In FIG. 4, Step S21 to Step S23 are similar to those in the flowchart of FIG. 3.

In the flowchart of FIG. 4, when it is determined that the processing executed by the information processing apparatus 1 relates to the processing of the first function controlled by the target sub-controller (the first sub-controller 111), the one or more main controllers 101 further determine whether to the entire information processing apparatus 1 or reset the target sub-controller, based on a processing stage of the processing executed by the information processing apparatus 1. Specifically, when it is determined that the processing executed by the information processing apparatus 1 relates to the processing of the first function controlled by the target sub-controller (Yes in Step S22), the one or more main controllers 101 determine whether the processing stage of the processing executed by the information processing apparatus 1 is a predetermined specific processing stage that is decided in advance (Step S25). For example, the specific processing stage is a processing stage that may affect control of the entire information processing apparatus 1. Whether the processing stage is the specific processing stage is stored in advance in the main storage 102, for example.

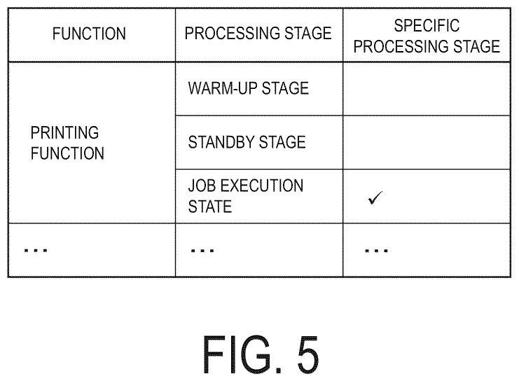

FIG. 5 is an example of a table that is stored in the main storage 102 of FIG. 1 and relates to the processing stages. For example, with reference to the table of FIG. 5, the one or more main controllers 101 determine whether the processing stage of the processing executed by the information processing apparatus 1 is the specific processing stage. The table of FIG. 5 is created in advance, and is stored in the main storage 102, for example.

As illustrated in FIG. 5, in the table, a function, one or more processing stages included in the function, and information indicating whether each processing stage is the specific processing stage are stored in association with one another. In the example of FIG. 5, the “printing function” is illustrated as a function. The printing function includes three processing stages, specifically, a warm-up stage, a standby stage, and a job execution stage. Whether the processing stage is the specific processing stage is indicated by a check mark. In the example of FIG. 5, the processing stage corresponding to the job execution stage is indicated as the specific processing stage.

In Step S25, with reference to, for example, the table illustrated in FIG. 5, the one or more main controllers 101 determine whether the processing stage of the processing executed by the information processing apparatus 1 is the specific processing stage. For example, when the processing stage of the processing executed by the information processing apparatus 1 is the warm-up stage or the standby stage, the one or more main controllers 101 determine that the processing stage of the processing executed by the information processing apparatus 1 is not the specific processing stage (No in Step S25). In such a case, the one or more main controllers 101 determine to reset the target sub-controller (the first sub-controller 111) (Step S23). When the processing stage of the processing executed by the information processing apparatus 1 is not the specific processing stage, the control of the entire information processing apparatus 1 is not affected. Thus, it is only required to reset the first sub-controller 111 where the WDT reset is executed.

In contrast, when the processing stage of the processing executed by the information processing apparatus 1 is the job execution stage, the one or more main controllers 101 determine that the processing stage of the processing executed by the information processing apparatus 1 is the specific processing stage (Yes in Step S25). In such a case, the one or more main controllers 101 determine to reset the information processing apparatus 1 (Step S24). When the processing stage of the processing executed by the information processing apparatus 1 is the specific processing stage, control of the entire information processing apparatus 1 may be affected. Thus, in order to prevent discrepancy in information recognition between the one or more main controllers 101 and the plurality of sub-controllers, the reset of the entire information processing apparatus 1 is conceived to be appropriate.

In this manner, when the WDT detects an occurrence of an abnormality, the information processing apparatus 1 according to the present embodiment determines whether to reset the entire information processing apparatus 1 or to reset the target sub-controller, based on whether the processing executed by the information processing apparatus 1 relates to the processing of the function controlled by the target sub-controller. Thus, the information processing apparatus 1 can appropriately set the reset range in accordance with the processing status where the WDT reset occurs. In this manner, the information processing apparatus 1 can improve usability by changing the reset range in accordance with the processing status.

Note that, in the embodiment described above, the processing when the WDT reset occurs in the first sub-controller 111 is described. However, when the WDT reset occurs in the second sub-controller 121, the reset range can also be set by processing similar to the processing described in the above-mentioned embodiment. This point is the same or similar in a case in which the number of the sub-controllers is three or more.

Although the present disclosure has been described based on the drawings and the embodiment, it is to be noted that those skilled in the art can easily make various variations and modifications based on the present disclosure. Thus, it is to be noted that these variations and modifications are included in the scope of the present disclosure. For example, the functions and the like that are included in the respective functional units or the respective steps can be rearranged so as not to be logically inconsistent, and a plurality of functional units or steps can be combined into one or divided.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An information processing apparatus comprising:
one or more main controllers that control processing of the entire information processing apparatus;
a plurality of sub-controllers that control processing of a function executable by the information processing apparatus; and
a watchdog timer that detects an occurrence of an abnormality in processing of a first function controlled by a first sub-controller among the plurality of sub-controllers, wherein
when the watchdog timer detects an occurrence of an abnormality, the one or more main controllers determine whether to reset the entire information processing apparatus or reset the first sub-controller, based on whether processing executed by the information processing apparatus relates to the processing of the first function controlled by the first sub-controller.

2. The information processing apparatus according to claim 1, wherein, when the processing executed by the information processing apparatus does not relate to the processing of the first function controlled by the first sub-controller, the one or more main controllers determine to reset the first sub-controller.

3. The information processing apparatus according to claim 1, wherein, when the processing executed by the information processing apparatus relates to the processing of the first function controlled by the first sub-controller, the one or more main controllers further determine whether to reset the entire information processing apparatus or reset the first sub-controller, based on a processing stage of the processing executed by the information processing apparatus.

4. An information processing method executed by an information processing apparatus comprising:
one or more main controllers that control processing of the entire information processing apparatus;
a plurality of sub-controllers that control processing of a function executable by the information processing apparatus; and
a watchdog timer that detects an occurrence of an abnormality in processing of a first function controlled by a first sub-controller among the plurality of sub-controllers, wherein
when the watchdog timer detects an occurrence of an abnormality, the one or more main controllers determine whether to reset the entire information processing apparatus or reset the first sub-controller, based on whether processing executed by the information processing apparatus relates to the processing of the first function controlled by the first sub-controller.

5. An image forming apparatus comprising:
one or more main controllers that control processing of the entire image forming apparatus;
a plurality of sub-controllers that control processing of a function executable by the image forming apparatus; and
a watchdog timer that detects an occurrence of an abnormality in processing of a first function controlled by a first sub-controller among the plurality of sub-controllers, wherein
when the watchdog timer detects an occurrence of an abnormality, the one or more main controllers determine whether to reset the entire image forming apparatus or reset the first sub-controller, based on whether a job executed by the image forming apparatus relates to the processing of the first function controlled by the first sub-controller.

6. The image forming device according to claim 5, wherein, when the job executed by the image forming apparatus does not relate to the processing of the first function controlled by the first sub-controller, the one or more main controllers determine to reset the first sub-controller.

7. The image forming device according to claim 5, wherein, when the job executed by the image forming apparatus relates to the processing of the first function controlled by the first sub-controller, the one or more main controllers further determine whether to reset the entire image forming apparatus or reset the first sub-controller, based on a processing stage of the job executed by the image forming apparatus.
